(19) United States
(12) Patent Application Publication
(10) Pub. No.: US 2025/0343686 A1
(43) Pub. Date: Nov. 6, 2025

(54) SYSTEMS AND METHODS FOR IMAGE PRIVACY

(71) Applicant: Xailient, Sydney (AU)

(72) Inventors: Herman Yau, Sydney (AU); Lars Oleson, Bondi (AU); Andy Atkinson, Sydney (AU); Mallika Patel, Sydney (AU)

(21) Appl. No.: 19/265,716

(22) Filed: Jul. 10, 2025

Related U.S. Application Data
(63) Continuation-in-part of application No. 18/406,499, filed on Jan. 8, 2024.
(60) Provisional application No. 63/479,097, filed on Jan. 9, 2023.

(51) Int. Cl. H04L 9/08; G06V 10/40; G06V 10/77; G06V 20/52; G06V 40/16; H04L 9/32

(52) U.S. Cl. CPC H04L 9/0866; G06V 10/40; G06V 10/7715; G06V 20/52; G06V 40/168; G06V 40/172; H04L 9/3231

(57) ABSTRACT

In one aspect, a system for implementing image privacy includes an image recording device configured to generate image data. The system includes a computing device in communication with the image recording device. The computing device is configured to detect a face within the image data using a facial recognition process. The computing device is configured to receive user authorization of a data process to be applied to the face, wherein the user authorization is unique to an identity of the face. The computing device is configured to communicate face data associated with the face to another computing device based on a result of the user authorization.

### CROSS-REFERENCE TO RELATED APPLICATIONS

This application is a continuation-in-part of U.S. application Ser. No. 18/406,499, filed Jan. 8, 2024, which claims priority to, and the benefit of, U.S. Provisional App. No. 63/479,097, filed Jan. 9, 2023, each of which are hereby incorporated herein by reference in their entireties for all purposes.

### TECHNICAL FIELD

The following disclosure is directed to systems and methods for image capture, user authorization, and privacy policies. In particular, the present disclosure is directed to systems and methods for image privacy.

### BACKGROUND

Modern camera security systems pose a privacy concern as video and/or images taken of individuals may be freely accessed and distributed without user consent. Further, privacy policies may vary in jurisdictions. Accordingly, systems and methods for security systems can be improved to implement enhanced privacy and security features.

### SUMMARY OF THE INVENTION

In one aspect, a system for implementing image privacy includes an image recording device configured to generate image data. The system includes a computing device in communication with the image recording device. The computing device is configured to detect a face within the image data using a facial recognition process. The computing device is configured to receive user authorization of a data process to be applied to the face, wherein the user authorization is unique to an identity of the face. The computing device is configured to communicate face data associated with the face to another computing device based on a result of the user authorization.

In another aspect, a method of implementing image privacy includes generating image data through an image recording device. The method includes communicating the image data to a computing device, detecting, through the computing device, a face within the image data using a facial recognition process, and receiving, at the computing device, user authorization of a data process to be applied to the face. The method also includes performing the data process based on a result of the user authorization.

### BRIEF DESCRIPTION OF THE DRAWINGS

FIG. 1 is a block diagram of an exemplary embodiment of a system for image privacy;

FIG. 2 illustrates an embodiment of a system for image privacy;

FIG. 3 illustrates an exemplary embodiment of a system for a user presence;

FIG. 4 illustrates an exemplary embodiment of a neural network;

FIG. 5 illustrates an exemplary embodiment of a neural node; and

FIG. 6 illustrates a machine learning module that may be implemented in the disclosed system and/or method.

### DETAILED DESCRIPTION

At a high level, aspects of the present disclosure are directed to enhancing and enforcing image privacy policies, which in certain cases can enforce user consents among a plurality of computing devices, and other embodiments facilitate the selection of computing devices that can perform certain data processes which in turn may enhance the security and privacy related to the use of facial recognition data.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

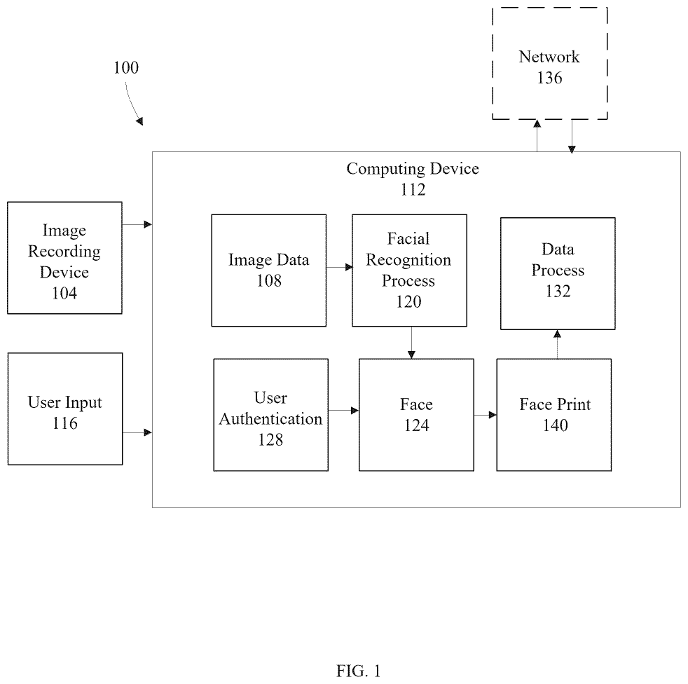

Referring to FIG. 1, system 100 for facilitating enhanced image privacy is presented. System 100 may include image recording device 104. An “image recording device” as used in this disclosure is an object (e.g., a camera) capable of recording photographic data, such as a security camera, surveillance camera, smartphone camera, and/or other camera that captures still and/or video images. Image recording device 104 may include a power supply, such as a wired, wireless, or other power supply. Image recording device 104 may be configured to generate image data 108 from an environment such as an immediate, adjacent, and/or other surrounding of image recording device 104. For instance and without limitation, image recording device 104 may be placed at a door of a building, in which an environment may include an area in front of the door. “Image data” as used in this disclosure is information pertaining to photographs, videos and/or one or more frames of video images. Image data 108 may include one or more pixels. A “pixel” as used in this disclosure is a smallest addressable element in a raster image. Image data 108 may include, without limitation, raster formats such as JPE, Exif, TIFF, GIF, BMP, and the like. Image data 108 may include vector formats, such as, without limitation, CGM, SVG, DXF, and/or other formats. Image recording device 104 may generate image data 108 in a JPEG format, with individual pixel values for each pixel. Pixels of image data 108 may include one or more pixel values, such as, without limitation, RGB values, YUV values, and/or other values. In some embodiments, pixel values may include a color space value, such as, but not limited to, red, green, blue, luma, chrominance, depth, and the like. Image recording device 104 may generate image data 108 in an SVG format with individual XML clement, such as, without limitation, vector graphic shapes, bitmap images, text, and the like.

Still referring to FIG. 1, image data 108 may include one or more pixel groups. A pixel group may include two or more pixels that may make up a larger singular pixel. A number of pixels in a pixel group may be referred to herein as a “resolution”, without limitation. Resolutions of image data 108 may include, but are not limited to, 640×480 (Standard Definition), 1280×720 (High Definition), 1920×1080 (Full High Definition), 2560×1440 (Quad High Definition), 2048×1080 (2K), 3840×2160 (4K), and/or 7680×4320 (8K). Image data 108 may include a number of bits per pixel (bpp). For instance, a 1 bpp image may use 1 bit for each pixel, such that each pixel may be on or off. Continuing this example, each additional bit may double a number of colors available, such as a 2bpp image having 4 colors, a 3 bpp image having 8 colors, a 4bpp image having 16 colors, and the like. Image data 108 may include a bpp value of anywhere between about 1 bpp to 24 bpp. Further image recording device 104 may include an image sensing device capable of sensing one or more megapixels, such as, without limitation, 4 megapixels, 10 megapixels, 16 megapixels, 24 megapixels, 64 megapixels, and the like.

Still referring to FIG. 1, image recording device 104 may be in communication with and/or include computing device 112. Computing device 112 may include a processor, memory, and the like. Computing device 112 may include any computing device as described in this disclosure, including without limitation a microcontroller, microprocessor, digital signal processor (DSP) and/or system on a chip (SoC) as described in this disclosure. Computing device 112 may include, be included in, and/or communicate with a mobile device such as a mobile telephone or smartphone, or internet of things (“IOT”) device such as a smart camera. Computing device 112 may include a single computing device operating independently, or may include two or more computing device operating in concert, in parallel, sequentially or the like; two or more computing devices may be included together in a single computing device or in two or more computing devices. Computing device 112 may interface or communicate with one or more additional devices as described below in further detail via a network interface device. Network interface device may be utilized for connecting computing device 112 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 112 may include but is not limited to, for example, a computing device or cluster of computing devices in a first location and a second computing device or cluster of computing devices in a second location. Computing device 112 may include one or more computing devices dedicated to data storage, security, distribution of traffic for load balancing, and the like. Computing device 112 may distribute one or more computing tasks as described below across a plurality of computing devices of computing device, which may operate in parallel, in series, redundantly, or in any other manner used for distribution of tasks or memory between computing devices. Computing device 112 may be implemented using a “shared nothing” architecture in which data is cached at the worker, in an embodiment, this may enable scalability of computing device 112 and/or another computing device.

With continued reference to FIG. 1, computing device 112, and/or any other computing device as described throughout this disclosure, may be designed and/or configured to perform any method, method step, or sequence of method steps in any embodiment described in this disclosure, in any order and with any degree of repetition. For instance, computing device 112 may be configured to perform a single step or sequence repeatedly until a desired or commanded outcome is achieved. Repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 112 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, computing device 112 may receive image data 108 from image recording device 104. In embodiments where computing device 112 may be part of image recording device 104, image data 108 may be transmitted through a wired connection. In other embodiments, image data 108 may be transmitted over a wireless connection. Computing device 112 may be configured to perform a facial recognition process 120 on image data 108. A “facial recognition process” as used in this disclosure is a computer function that detects one or more faces. Facial recognition process 120 may include a machine learning process. A “machine learning process” as used in this disclosure is a computer algorithm that is trained with training data to output a certain element given an input. Machine learning processes may include, but are not limited to, supervised machine learning processes, unsupervised machine learning processes, and the like. Facial recognition process 120 may employ one or more neural networks. A neural network may include a set of one or more nodes for example, a neural network, also known as an artificial neural network, is a network of “nodes,” or data structures having one or more inputs, one or more outputs, and a function determining outputs based on inputs. Such nodes may be organized in a network, such as without limitation a convolutional neural network (CNN), including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 1, a node may include, without limitation a plurality of inputs that may receive numerical values from inputs to a neural network containing the node and/or from other nodes. A node may perform a weighted sum of inputs using weights that are multiplied by respective inputs. Additionally or alternatively, a bias may be added to the weighted sum of the inputs such that an offset is added to each unit in the neural network layer that is independent of the input to the layer. The weighted sum may then be input into a function, which may generate one or more outputs. Weights applied to an input may indicate whether the input is “excitatory,” indicating that it has strong influence on one or more outputs, for instance by the corresponding weight having a large numerical value. Weights applied may indicate whether the input is “inhibitory,” indicating it has a weak influence on the one more inputs, for instance by the corresponding weight having a small numerical value. The values of weights may be determined by training a neural network using training data, which may be performed using any suitable process as described above. In an embodiment, and without limitation, a neural network may receive semantic units as inputs and output vectors representing such semantic units according to weights that are derived using machine-learning processes as described in this disclosure.

Still referring to FIG. 1, facial recognition process 120 may utilize one or more sets of training data. “Training data” as used in this disclosure is data containing correlations that a machine-learning process may use to model relationships between two or more categories of data elements. In certain implementations, different individual datasets may be created and maintained that are specific to a particular domain—e.g., a training dataset may be developed and used to process images for reading license plates, another dataset for facial detection and recognition, and yet another for object detection used in an autonomous driving context. By using domain-specific training datasets as the basis for subsequent network processing, the processing and power efficiencies of the system are optimized, allowing processing to occur on “edge” devices (internet of things devices, mobile phones, automobiles, security cameras, etc.) without compromising accuracy.

With continued reference to FIG. 1, in some embodiments, a training dataset may be created through identifying a first set of images for a particular domain (e.g., frames from a multitude of surveillance cameras at an airport). A specific property, such as “does this image include a face” may be selected as a property of interest. In some cases, the same set of images may be used to create multiple training datasets, using a different property of interest. A user may label the pixels (or sets of pixels) as either “interesting” or “uninteresting” creating an array describing the image with respect to the property of interest. In some cases, labeling may be done using automated processes such as supervised or semi-supervised artificial intelligence. This may, for example, take the form of an array label of 1's and 0's, with 1's representing pixels of interest (e.g., these pixels represent a face) and 0's representing pixels that are not of interest (e.g., background, etc.).

Still referring to FIG. 1, in some cases, pixels of image data 108 may be grouped and represented as a plurality of different channels within an image, effectively decomposing the image into a set of composite images such that each channel may be individually processed. This approach may be beneficial when an image includes multiple different areas of interest (e.g., more than one image of a person, or an image with different objects along a street scene), and the different channels are processed using different networks. In other cases, an image of image data 108 may be processed as a single channel. In various examples, training of an object detection and classification system can be achieved using either single or multi-step processes, without limitation. In some examples, facial recognition process 120 may be trained using stochastic gradient descent and back-propagation. For example, a set of initial starting parameters are identified, which may be further refined using the training images and output a convolutional feature map with trained proposals in an iterative process.

Continuing to refer to FIG. 1, in various examples, facial recognition process 120 may be trained using a single-step process using back-propagation. For instance, a machine learning module of facial recognition process 120 may initialize an initial processing module, an object proposal module and an object classifier module with starting parameters. After initialization, a machine learning module of facial recognition process 120 can process a training image through an initial processing module, an object proposal module, and an object classifier module. Using back-propagation, a machine learning module of facial recognition process 120 can score the output proposals, classifications, and confidence scores based on data corresponding to the training image. A machine learning module can train parameters in an initial processing module, an object proposal module, and an object classifier module, in order to improve the accuracy of the output object classifications and confidence scores. In various examples, a machine learning process can train the facial recognition process 120 in an initial set-up. In other examples, a machine learning process can train facial recognition process 120 periodically, such as, for example, at a specified time each week or month, or when the amount of new data (e.g., new images) reaches a threshold. For example, new images may be retrieved from edge devices over time (either continuously while connected to a centralized cloud-based system or asynchronously when such connections and/or the requisite bandwidth are available). In some examples, a machine learning process may receive updated images for subsequent training when manually collected by a user. In some instances, collection rules may be defined by a user or be provided with facial recognition process 120 itself, or in yet other cases, automatically generated based on user-defined goals. For example, a user may determine that a particular object type is more interesting than others, and as such when facial recognition process 120 recognizes such objects those images are collected and used for further training iterations, whereas other images may be ignored or collected less frequently. In either instance, the subsequent processing of an image may occur on a channel by channel basis (a single channel at a time). As such, images that have been modeled as multiple channels may be converted to a single channel. In one embodiment, a random number between a minimum and maximum pixel value within the pixel group is selected and used as the basis for the conversion.

Still referring to FIG. 1, facial recognition process 120 may include downsampling image data 108 into a value map. Downsampling image data 108 may include grouping two or more pixels into a pixel group. Downsampling may include determining an optimal group size, shape or both of one or more pixels of image data 108. For example, a 4×6 area of 24 pixels may be combined and analyzed as a single pixel group through facial recognition process 120. A pixel group may be assigned a pixel group value based on the pixel values of each of the two or more pixels associated with the group of pixels. According to one embodiment, two or more pixels may each include pixel values such as red, green, and blue. According to various embodiments, other pixel values may include YUV (e.g., luma values, blue projection values, red projection values), CMYK (e.g., cyan values, magenta values, yellow values, black values), multi-color channels, hyperspectral channels, or any other data associated with digitally recording electromagnetic radiation or assembling a digital image. In some cases, each pixel group's value is determined by determining the pixel value of the pixel values associated with the pixel group. In other instances, the pixel group value may be determined based on an average pixel value, or some other threshold value (e.g., a percentage of the maximum pixel value). The value may be determined as a summary of the image data channels, such as RGB, YUV or other channel. A summary transformation may for example, be the average, maximum, harmonic mean, or other mathematical summary of the values associated with each pixel group. A value map may be generated based on a combination of one or more pixel group values.

With continued reference to FIG. 1, facial recognition process 120 may include processing a value map using a neural network to determine a probability heat map. A probability heat map may include groups of graded values. Graded values may be indicative of a probability that a respective pixel group includes a representation of an object of interest, such as without limitation a face. Facial recognition process 120 may include detecting which groups of graded values meet a determined probability threshold. According to some embodiments, a determined probability threshold may be predetermined by a user. According to further embodiments, a determined probability threshold may be dynamically determined programmatically. Dynamically determining the determined threshold may include various subroutine functions, predetermined rules, or statistical algorithms. For example, dynamic determination may include using curve fit statistical analysis, such as interpolation, smoothing, regression analysis, extrapolation, among many others, to determine the determined probability threshold for that particular image or data set.

Continuing to refer to FIG. 1, according to some embodiments, graded values may include various ranges, including zero (0) to one (1) or zero to one-hundred (100). The graded values may be indicative of the probability that the respective pixel group includes a representation of an object of interest. Groups of graded values that meet the predetermined probability threshold are identified as zones of interest, according to some embodiments. For example, if the predetermined probability threshold is set at 0.5, the groups of graded values greater than or equal to 0.5 (e.g., 0.5-1.0) will be identified as zones of interest. Facial recognition process 120 may include a first neural net and a second neural net. A “first neural net” as used in this disclosure is an initial neural network. A “second neural net” as used in this disclosure is a neural network subsequent to an initial neural network. In some embodiments, a first neural network and/or a second neural network may include a same neural network type. In other embodiments, a first neural network and/or a second neural network may include a differing network type. Neural network types may include, without limitation, feed forward networks, multi-layer perceptron networks, radial based networks, convolutional neural networks, recurrent neural networks, and/or long short term neural network. Facial recognition process 120 may include processing zones of interest to detect objects of interest therein using a second neural network, according to some embodiments. Objects of interest may be defined dynamically by a continuous machine learning process and identified by the application of such machine learning data, according to some embodiments. Other embodiments may define objects of interest using predetermined characteristics and/or classifications that are assigned by an outside entity. A second neural network receives as input image data within the zones of interest. According to some embodiments, the image data may include downscaled representations of the originally received image data or the originally received image data itself or a mosaic combining downscaled representations of the regions of interest of the originally received image. The second neural network generates as output a representation of the objects of interest, according to some embodiments. A representation of the objects of interest may include one or more of the following: a classification for each object of interest and coordinates indicative of the location of each object of interest within the originally received image data. According to some embodiments, facial recognition process 120 may repeat continuously until the process is terminated. For example, facial recognition process 120 may repeat for every new image dataset that is made available to the system.

Still referring to FIG. 1, facial recognition process 120 may detect and/or generate one or more detected faces 124. Face 124 may be a human face. Face 124 may include, without limitation, checks, jawbones, foreheads, noses, eyes, lips, mouths, teeth, hair, and/or other elements of a human head. Face 124 may include a portion of image data 108 that illustrates a part and/or whole of a human face. Face 124 may include a side-profile view, front-profile view, and/or a combination thereof of one or more human faces. According to some embodiments, facial recognition process 120 may further detect and/or generate face descriptions of face 124. Face descriptions may include, without limitation, “man”, “woman”, “old”, “young”, “middle aged”, “Caucasian”, “African American”, “Asian”, “pacific islander”, and the like. Facial recognition process 120 may be trained with training data correlating image data to one or more face descriptions. Training data may be received through user input, one or more external computing devices, and/or previous iterations of processing. Facial recognition process 120 may input image data 108 and output faces 124 with corresponding face descriptions based on training with training data correlating image data to one or more face descriptions. Facial recognition process 120 may generate a confidence score of each face description of face 124. A confidence score may include, but is not limited to, a numerical value, percentage, and the like. For instance, and without limitation, a confidence score of face 124 may include a value of 0.95 out of 1, indicating a high confidence in a face description of a middle aged Asian woman.

Still referring to FIG. 1, computing device 112 may be configured to receive user input 116. “User input” as used in this disclosure is a form of data entry from an individual/User input 116 may include input through a graphical user interface (GUI). A GUI may display one or more user input fields, such as, but not limited to, text fields, search fields, buttons, and the like. Computing device 112 may prompt a user to provide user input 116, such as through a question displayed through a GUI. For instance and without limitation, computing device 112 may display, through a GUI, a text string of “Do you agree to the terms of facial recognition and data collection?” to which user input 116 may include an interaction with a “yes” or “no” button displayed on the GUI. A user may provide user input through, without limitation, touch input, mouse input, virtual reality (VR) controllers and/or headsets, and the like.

Still referring to FIG. 1, user input 116 may include user authorization 128. A “user authorization” as used in this disclosure is a permission granted or denied by a user for use of one or more sets of data by a computing device and/or operator. User authorization 128 may include, without limitation, a positive consent, negative consent, and the like. A “positive consent” as used in this disclosure refers to an agreement of an event. A “negative consent” as used in this disclosure refers to a disagreement of an event. Events may include, without limitation, utilization of face data of face 124, communication of face data of face 124, and/or other processes that may utilize face data of a user's face 124 and/or image data 108 representing face 124. User authorization 128 may include a positive consent for one or more processes relating to data of their or someone else's face 124. User authorization 128 may include a time period. A time period may include, without limitation, seconds, minutes, hours, days, weeks, months, years, and the like. User authorization 128 may include a time period of positive consent. As a non-limiting example, user authorization 128 may include a positive consent of face data use for 12 hours.

With continued reference to FIG. 1, computing device 112 may generate face print 140 from face 124. A “face print” as used in this disclosure is a digital summary generated from an individual's face. Face print 140 may include, but is not limited to, one or more geometries of a face. Geometries of a face may include, without limitation, distance between eyes, forehead length, mouth shape, cheekbone structure, and the like. Computing device 112 may utilize depth data of image data 108. Depth data may be generated from a depth sensor of image recording device 104. A depth sensor of image recording device 104 may include, without limitation, an active sensor, passive sensor, and the like. An active depth sensor may include a sensing device that may be configured to emit electromagnetic radiation and detect a bounce back off the electromagnetic radiation to determine a time of travel of the electromagnetic radiation. Electromagnetic radiation may include radiation on an infrared spectrum, without limitation. A passive depth sensor may include a sensing device that utilizes existing light sources to generate a three-dimensional map of an area. Computing device 112 may generate a three-dimensional (3D) face 124 through depth data of image data 112. For instance and without limitation, image sensing device 104 may project and read 30,000 infrared dots on a user's face, to which computing device 112 may generate a face mesh of the user's face. A facial mesh may include a positioning of one or more geometries and/or points of a user's face. Computing device 112 may associate facial meshes and 3D geometries of face 124 with one or more identities of face print 124. As a non-limiting example, face print 140 may include a 3D facial mesh of a user associated with an identity of “John Smith”. Computing device 112 may store one or more face prints 140 in a database, such as, without limitation, a local database, cloud storage, and the like.

Still referring to FIG. 1, face print 140 may include a pseudonymous user identification. A “pseudonymous user identification” as used in this disclosure is a user credential under an anonymous name. Pseudonymous user identification may include a string of random letters, numbers, and/or other characters that identify an individual. A pseudonymous user identification may include colloquial strings of characters, such as “User 1”, without limitation. Computing device 112 may associate one or more face prints 140 with one or more pseudonymous user identifications. In some embodiments, computing device 112 may generate a pseudonymous user identification in a local context. A local context may include, but is not limited to, entering a security door, logging into a smartphone, and the like. Computing device 112 may generate temporary pseudonymous user identifications for a period of time. A temporary pseudonymous user identification may be erased after a given amount of time, such as, without limitation, one or more minutes, hours, days, and the like. A geometry of face 124 of face print 140 may remain when a pseudonymous user identification may be erased, such that face print 140 retains a geometry of a face, which may be used to improve facial recognition process 120. As a non-limiting example, computing device 112 may generate a temporary pseudonymous user identification of a face print 140 of a house guest for 3 hours, at which point the temporary pseudonymous user identification may be erased. In some embodiments, both face print 140 and a pseudonymous user identification may be erased after a certain period of time. Continuing the above example, after 3 hours, computing device 112 may delete face print 140 of the house guest, which may include a pseudonymous user identification and/or one or more geometries of face 124. Computing device 112 may generate a pseudonymous user identification of face print 140 over a local and/or exterior context. An exterior context may include, without limitation, a network of devices, such as one or more image recording devices 104 across a security building, brand of smartphones, smart home devices, and the like. Computing device 112 may generate temporary pseudonymous user identifications of face print 140 for exterior and/or local contexts. For example, and without limitation, a pseudonymous user identification of face print 140 may include a pseudonymous user identification that may be used throughout a security system of a building until 5:00 PM EST, at which face print 140 and/or a pseudonymous user identification of face print 140 may be deleted.

Still referring to FIG. 1, computing device 112 may utilize face 124 in one or more data processes 132. A “data process” as used in this disclosure is a procedure utilizing information of an individual. Data process 132 may include, without limitation, using facial recognition to grant access to security systems, sharing face data with external computing devices, storing data of face 124, and the like. Data process 132 may include unlocking one or more smartphones, tablets, laptops, monitors, door security systems, and the like. Data process 132 may include using an authorized face to exchange currency between two or more entities, such as using an authorized face to checkout an e-commerce shopping cart.

Still referring to FIG. 1, data process 132 may include communicating and/or sharing data of face 124 with a network, such as network 136. Network 136 may include an individual computing device, plurality of computing devices, cloud-computing network, servers, application programming interfaces (API), and the like. Network 136 may include a plurality of image recording devices and/or computing devices in communication with the plurality of image recording devices. For instance, network 136 may include a smart home security system. Network 136 may include specific brands of devices, such as, but not limited to, Apple, Samsung, Google, Amazon, Microsoft, Meta, and the like.

Still referring to FIG. 1, face print 140 may include one or more lists of user authorizations 128. For instance, and without limitation, a face print 140 may include a list of devices and/or networks a user has granted permission to run data process 132. Face print 140 may include a list of data processes 132 and/or devices associated with those processes that a user has given permission to. Computing device 112 may store and/or communicate a list of one or more data process 132 having a positive consent, negative consent, and/or one or more devices associated with the data processes 132. User authorization 128 may include a positive consent for a specific data process 132 across a plurality of devices, such as a data process 132 of security access. In other embodiments, user authorization 128 may include a positive consent for specific devices. As a non-limiting example, user authorization 128 may include a positive consent for a smartphone to perform one or more data processes 132. Computing device 112 may communicate with one or more computing devices, such as through network 138 to enforce consents of user authorization 128.

Still referring to FIG. 1, computing device 112 may store one or more lists, faces 124 and/or face prints 140 in a facial database. A “facial database” as used in this disclosure is a collection of data relating to faces. A facial database may include geometries of one or more faces 124, user authorizations 128 linked to one or more faces 124, face prints 140, positive consent for one or more data process 132 linked to one or more face prints 140, and the like. Computing device 112 may be configured to compare image data 108 with one or more sets of data in a facial database, such as face prints 140. Computing device 112 may compare user input 116 with stored user authorization 128 of a facial database to ensure authenticity of user input 116, such as, without limitation, a login request to one or more software platforms. In some embodiments, computing device 112 may include a local facial database that may be updated and/or shared with an external database, such as a cloud-computing network. For instance, computing device 112 may have a local storage system for a residential security camera. Computing device 112 may have user authorization 128 including a negative consent for data process 132. Computing device 112 may communicate with an external computing device and/or cloud-computing network that may include a storage including a user authorization 128 having a positive consent for data process 132. Computing device 112 may override user authorization 128 of an external computing device. In other embodiments, an external computing device may override user authorization 128 of a local storage system of computing device 112. One or more computing devices 112 may synchronize face print 140 and/or user authorization 128 across a plurality of devices, such as network 136. In other embodiments, each device of computing device 112 and/or network 136 may operate independently of other devices of network 136. For instance and without limitation, a local smart home system may include a door camera, kitchen camera, and/or smartphone camera. A smartphone camera may store user authorization 128 and/or face print 140 that may differ from user authorization 128 and/or a face print 140 of the door camera, kitchen camera, and the like. In other embodiments, each device may be synchronized such that a user “presence” may be created. A user presence refers to an acknowledgement of an individual within a network. A user presence may include one or more computing devices 112 sharing one or more faces 124 and/or face prints 140 such that each device may recognize an identity of a user across devices. A user presence may include sharing user authorization 128 across a plurality of devices which may allow for seamless interaction between two or more devices. For instance, and without limitation, a user may approach a door security camera which may recognize the user and grant the user access to a door of a building. The user may continue walking into a kitchen area, which may have a kitchen camera. The kitchen camera may recognize the user and allow the user access to one or more food items, such as of a fridge.

Still referring to FIG. 1, computing device 112 may be configured to identify a positive consent face 124 from a plurality of faces of image data 108. Image recording device 104 and/or a plurality of image recording devices 104 may generate image data 108 which may include one or more faces. Computing device 112 may sort or otherwise filter faces 124 of image data 108 as a function of one or more criterion. Criteria may include, without limitation, positive consent of user authorization 128, identifiers of face print 140 such as geometric shapes of face 124, and the like. Computing device 112 may continuously identify and/or filter through real-time image data 108 of one or more image recording devices 104. For instance, and without limitation, four individuals may be detected in image data 108 by computing device 112. Computing device 112 may identify face print 140 of face 124 of a first individual and a third individual, where the face prints 140 of the first individual and the third individual have user authorization 128 of a positive consent. Computing device 112 may perform one or more data processes 132 for the first individual and the third individual. Continuing this example, a second individual and a fourth individual of the four individuals may have a negative consent of user authorization 128 and/or may not have registered their faces 124 for face print 140. Computing device 112 may cease any data collection and/or processing of data of the second and fourth individuals based on the negative consent and/or unregistered face. In some embodiments, each detected face 124 of a plurality of faces 124 may be compared by computing device 112 to an on-camera gallery of detected faces 124 and/or face prints 140 of image recording device 104. In other embodiments, computing device 112 may compare detected faces 124 of a plurality of faces 124 with one or more databases and/or galleries of faces 120 that may be stored external to image recording device 104, such as in one or more databases of network 136.

With continued reference to FIG. 1, computing device 112 may perform various functions based on an unrecognized and/or negative consenting face of faces 124. Computing device 112 may flag or otherwise tag a frame of a video, an image, and the like, as “unknown subject”, which may be sent to a cloud-computing network, such as network 138. In some embodiments, computing device 112 may insert data into meta data of image data 108 referring to an unrecognized and/or negative consenting individual. In some embodiments, computing device 112 may generate one or more alerts based on faces 124. An alert may include a push notification such as, but not limited to, a text, e-mail, call, GUI pop-up, and the like. Computing device 112 may generate an alert that an unrecognized and/or negative consenting individual was detected and prevent one or more portions of image data 108 including the unrecognized and/or negative consenting individual from being communicated with other computing devices, such as a cloud-computing network. In other embodiments, computing device 112 may obscure and/or redact face 124 of an unrecognized and/or negative consenting individual from image data 108. Obscurement may include, without limitation, pixelation, black box placements, masking layers such as green circles, and the like around one or more parts of face 124 of an unrecognized and/or negative consenting individual. An obscurement and/or redaction may be reversible so that an original image of an unrecognized and/or negative consenting individual may be restored. Computing device 112 may communicate an obscured and/or redacted image with one or more computing devices, such as through network 138.

Still referring to FIG. 1, computing device 112 may be configured to generate an ignore list of one or more users. An “ignore list” as used in this disclosure is a dataset of one or more faces and/or identities associated with one or more faces that are not processed. An ignore list may include a plurality of faces 124, face prints 140, and the like, which may include negative consent of user authorization 128. For instance, and without limitation, computing device 112 may recognize a user's face 124 and cease any data processing 132 of the user's face 124. Computing device 112 may remove any images of image data 108 that may have a user's face 124 of a user on an ignore list. Computing device 112 may further remove any record and/or event stored relating to an ignored user's face 124 based on the ignored user's status on an ignore list. In some embodiments, computing device 12 may compare an unrecognized face 124 to one or more “expected stranger” lists. An expected stranger list may include one or more names, photos, and the like of one or more individuals that may be expected to become within proximity of computing device 112. Computing device 112 may determine an unrecognized face 124 is on an expected strangers lists, and not generate any alert based on the status of the unrecognized face 124 on the expected strangers list. In some embodiments, computing device 112 may automatically generate an expected strangers list based on, without limitation, delivery notifications, histories of past stranger arrivals, and the like. Computing device 112 may correlate one or more events with one or more faces 124.

Still referring to FIG. 1, computing device 112 may be configured to determine a compliance of one or more operators of image recording device 104. A compliance may include one or more permitted actions of one or more individuals within, but not limited to, cities, towns, states, countries, counties, and the like. Computing device 112 may communicate with one or more external computing networks, such as network 138, to receive a list of one or more permitted actions. In some embodiments, permitted actions may be relevant to privacy rules and/or laws of certain jurisdictions. For instance and without limitation, permitted actions may include utilizing an individual's face geometry to unlock a mobile application, utilizing artificial intelligence (AI) for facial recognition, linking a user's face to one or more events, storing images of one or more faces, and the like. Computing device 112 may generate one or more queries for jurisdictional privacy policy data. Queries may include searches through one or more databases, such as, but not limited to, the Internet, law enforcement agency databases, and the like. Queries may include one or more querying criterion, such as, but not limited to, one or more words, phrases, symbols, characters, and the like. Querying criterion may include one or more words, such as “privacy”, “video”, “artificial intelligence”, and the like. Computing device 112 may utilize a language processing model to extract jurisdictional privacy policy data from one or more external databases. A language processing model may be configured to input text and output associated of text and one or more categories. Categories may include, but are not limited to, local privacy laws, video laws, camera laws, and the like. Computing device 112 may generate one or more settings of image recording device 104 based on results of one or more queries, outputs of one or more language processing models, and the like.

Still referring to FIG. 1, computing device 112 may be configured to determine a compliancy of image recording device 104 based on a location of image recording device 104. In some embodiments, a breach of compliance may be detected by computing device 112. Computing device 112 may generate one or more alerts for a user informing the user that they may be breaching one or more privacy policies of local jurisdictions. In some embodiments, computing device 112 may be configured to switch one or more modes of operation to automatically be in compliance with one or more privacy policies of local jurisdictions. For instance and without limitation, a user may be in an “opt-in” jurisdiction and travel to an “opt-out” jurisdiction, which computing device 112 may automatically update image recording device 104 to be in compliance with an opt-out jurisdiction and/or generate an alert of one or more privacy policies of an opt-out jurisdiction. Computing device 112 may determine and/or store one or more default settings for image recording device 104. Default settings may be configured and/or updated by computing device 112 to be in compliance with one or more privacy policies of one or more local jurisdictions. Computing device 112 may compare past privacy policy and/or consent changes, jurisdiction privacy policy changes, and the like, to correlate and/or determine compliancy of one or more permitted actions in one or more jurisdictions.

Computing device 112 may be configured to perform a distributed face recognition. In some embodiments, a distributed face recognition includes computing device 112 verifying face 124 matches a pre-registered face 124 and/or face print 140 and perform data process 132 with image data 108 including face 124 without identifying an identity of one or more bystanders. A distributed face recognition may include computing device 112 detecting a plurality of faces 124 and/or face prints 140 of a plurality of individuals. Each detection of face 124 of each individual in a plurality of individuals may be compared to privacy requirements of one or more jurisdictions. For instance, each face 124 may be compared to residential jurisdictional requirements, business jurisdictional requirements, town jurisdictional privacy requirements, state jurisdiction privacy requirements, and/or country jurisdictional privacy requirements. Each jurisdictional privacy requirement may have specific laws against a use of face print 140. Computing device 112 may compare jurisdictional requirements to determine one or more actions to be taken with face print 140.

In some embodiments, image recording device 104 may generate image data 108, which computing device 112 may strip of any identifying information, such as locational data, data identifying image recording device 104, and the like. De-identified image data 108 may be stored at a single site, such as a home, singular place of business, and the like. In embodiments where computing device 112 is part of image recording device 104, computing device 112 may generate face prints 140 of detected faces 124 of image data 108 in real-time on image recording device 104. Face print 140 may be compared to an on-device cache of face prints 140 of image recording device 104. If no match for a face print 140 of a user is found on a local cache of face prints 140 of image recording device 104, computing device 112 may escalate a search to an on-premise server of a residence or business. For instance, network 136 may be an on-premise server of a residence or business and may have one or more databases or caches of face prints 140. Computing device 112 may compare face prints 140 to a cache of face prints 140 of a server, such as network 136. Based on jurisdictional privacy requirements, such as for residencies, business, cities, towns, states, countries, and the like, a transmission of face print 140 may from image recording device 104 to network 136 or another server may not be allowed. Computing device 112 may compare one or more jurisdictional requirements to determine if transmission of face print 140 between image recording device 104 and network 136 is allowed. If transmission of face print 140 is not allowed, image data 108 of a face crop of face 124 may be used instead and face print 140 may be recalculated on a server for matching against a server database, such as network 136. If transmission of face print 140 is allowed, face print 140 may be used by image recording device 104 and a server, such as network 136, to perform a face print 140 database lookup. If no match is found at a server level, computing device 112 may escalate to a system-wide cache to determine a match of face print 140 to a stored face print 140. If a match is found, face print 140 may be added to a cache of face prints 140 of image recording device 104.

As a non-limiting example, image recording device 104 may reside in a slot machine of a casino. Slot machines of casinos may be required to verify an active player matches an authorized player list. Image recording device 104 may generate face print 140 from image data 108 of a slot machine player and attempt to match the face print 140 to an on-device cache of face prints 140 of image recording device 104. If no match is found, computing device 112, which may reside in image recording device 104, may determine jurisdictional privacy requirements of the casino, a city the casino is in, a state the casino is in, a country the casino is in, and the like to determine if transmission of face print 140 to an on-site server, such as network 136, is lawful. If transmission of face print 140 to an on-site server is not lawful, computing device 112 may instead transmit image data 108 including a detected face 124 to a server, such as network 136. Network 136 and/or another server may generate a face print 140 base don image data 108 transmitted from image recording device 104 to determine a match of face print 140 to a cache of face prints 140 of network 136. If no match is found, network 136 may communicate face print 140 to a system-wide cache to determine a matching face print 140. If a match of face print 140 and a face print 140 of a cache is found, face print 140 may be added to an on-device cache of image recording device 104. If transmission of face print 140 is lawful, network 136 may receive face print 140 as is without having to reconstruct face print 140 based on image data 108 and/or face 124.

In some embodiments, computing device 112 may account for various jurisdictional privacy requirements of various jurisdictions. For instance, transmission and/or use of face print 140 may be lawful in the United States but may not be lawful in the European Union. Computing device 112 may compare jurisdictional requirements where image recording device 104 and/or network 136 reside. For instance in the above non-limiting example, image recording device 104 may reside in a casino in the United States, which may allow use of and transmission of face print 140. However, network 136 may reside in a European Union country, which may not allow use of or transmission of face print 140. Computing device 112 may adjust use of face print 140 to account for the varying jurisdictional requirements of the European Union with respect to network 136. Likewise, based on where image recording device 104 resides, computing device 112 may adjust operations to comply with local jurisdictional requirements, such as use of face print 140 in one or more data processes 132.

With continued reference to FIG. 1, computing device 112 may be configured to encrypt face print 140. Encryption may include any form of encryption, such as, but not limited to, Advanced Encryption Standard (AES), elliptic-curve cryptography, twofish encryption, asymmetric encryption, Rivest-Shamir-Adleman (RSA) encryption, or other forms of encryption. Computing device 112 may be configured to communicate an encrypted face print 140 to one or more external computing devices through a network. Networks may include local area networks (LAN), the internet, or other networks of two or more computing devices. In some embodiments, computing device 112 may be configured to communicate an encrypted or non-encrypted face print 140 to a smart lock. A “smart lock” as used in this disclosure is a device capable of receiving data and performing a locking or unlocking operation based on the data. A smart lock may include a processor, a memory, a storage device, and/or a camera. A smart lock may be an electromechanical lock with a communication module. A communication module of a smart lock may be a Bluetooth, Wi-Fi, cellular, or other communication module. In some embodiments, a smart lock may include a locking mechanism. A “locking mechanism” as used in this disclosure is a structure of components that enable or disable a movement of an object. For instance, locking mechanisms may include, but are not limited to, electromechanical locks, pin and tumbler locks, or other locking mechanisms. A locking mechanism of a smart lock may allow for the smart lock to lock or unlock itself. A smart lock may be part of, but is not limited to, an office door, a residential door, a commercial door, a car door, a desk, a safe, or any other object that may incorporate a lock.

In some embodiments, a smart lock may include an imaging system, such as one or more image sensors or cameras, without limitation. A smart lock may include a memory that may store any data described herein. For instance, a smart lock may store one or more face prints 140, transmission data, image data, encryption data, or other data. A smart lock may be configured to receive an encrypted face print 140 via computing device 112. For instance, computing device 112 may communicate an encrypted face print 140 to a smart lock over a wired or wireless connection. A smart lock may be configured to decrypt an encrypted face print 140. Decryption may include converting ciphertext of an encrypted file into plain text. In some embodiments, a smart lock may store a decryption key specific to an encrypted face print 140. In some embodiments, an encrypted face print may be non-decryptable if intercepted due to decryption data being associated with a smart lock. A smart lock may receive an encrypted face print 140 from computing device 112 and may use one or more decryption keys to decrypt the encrypted face print 140. A smart lock may store one or more decryption keys that may be specific to an encrypted face print 140. In some embodiments, a first smart lock may store a first decryption key and a second smart lock may store a second decryption key, the first decryption key allowing decryption of a first face print and the second decryption key allowing for decryption of a second face print. In some embodiments, a smart lock may be configured to compare a decrypted face print 140 with image data received from one or more imaging systems. For instance, an individual may approach a smart lock, to which smart lock may obtain image data of the individual. In some embodiments, a smart lock may perform a facial recognition process. A smart lock may perform a facial recognition process to identify one or more facial features of an individual. A smart lock may compare one or more facial features with an individual with one or more face prints 140. In some embodiments, if a smart lock determines a match between image data and face print 140, the smart lock may actuate a locking mechanism to unlock itself. In some embodiments, if a smart lock determines no match to be found between image data and face print 140, it may take no locking action or may ensure it is in a locked state. In some embodiments, a smart lock may actuate a locking mechanism if all individuals at a smart lock match a corresponding face print 140. For instance, two individuals may approach a smart lock, one with a corresponding face print 140 and one without. A smart lock may not actuate a locking mechanism due to an unidentified individual present with an identified individual. In some embodiments, a smart lock may be configured to receive, decrypt, and compare face prints 140 to multiple individuals. For instance, two individuals may approach a smart lock, each individual having a corresponding face print 140. A smart lock may decrypt two face prints 140 and compare each face print 140 to one or more facial features obtained from either or both of two or more individuals. Upon a match between two or more individuals to corresponding face prints 140, a smart lock may actuate a locking mechanism.

In some embodiments, a face print 140 may be assigned to a smart lock out of a plurality of smart locks. For instance, a first face print may be assigned to a first smart lock, a second face print may be assigned to a second smart lock, and so on. Each smart lock may receive and decrypt a face print assigned to themselves. In some embodiments, face print 140 may be assigned to a smart lock based on a location associated with the smart lock. Locations may be obtained through, but not limited to, global positioning systems (GPS), internet protocol address, Bluetooth signaling, or other systems. For instance and without limitation, a smart lock may be positioned at an office, hotel room, house, or other location associated with an individual and may be assigned a face print 140 corresponding to the individual. In some embodiments, a single smart lock may be assigned two or more face prints 140 for a single location. As a non-limiting example, computing device 112 may generate face print 140 and may encrypt face print 140. Computing device 112 may communicate an encrypted face print to a third-party networking system. A third-party networking system may include any networking system of a third-party, such as, but not limited to, a hotel network system, gym networking system, office networking system, or other networking system. A third-party networking system may forward the encrypted face print to one or more smart locks of a hotel room that an individual has reserved. The smart lock may decrypt the face print 140. An individual may approach a hotel room and may present his or her face to a camera of a smart lock of the hotel room. The smart lock may compare one or more facial features of the individual with one or more face prints 140. Upon a match determined by the smart lock of facial features associated with an individual and face print 140, the smart lock may actuate a locking mechanism causing the hotel door to become unlocked. If no match is determined, the smart lock may take no action if the hotel door is in a locked state, or may actuate a locking mechanism to lock the hotel door if the hotel door was unlocked.

Still referring to FIG. 1, in some embodiments, a secondary encryption salt and/or secret may be combined with a public key that may result in a private key associated with a smart lock being insufficient to decrypt an encrypted face print. For instance, a second encryption salt and/or secret may be added with a public key associated with a smart lock. A second encryption salt and/or secret may be, but is not limited to, a personal identification number (PIN), password, key phrase, or other combination of characters and/or symbols. A user may present a second unshared secret to a smart lock, which may allow the smart lock to decrypt an encrypted face print. In some embodiments, encryption of face print 140 may be based on a destination of face print 140, such as a location of a smart lock. For instance, once within a certain geo-perimeter, a smart lock may be able to obtain decryption data to decrypt an encrypted face print. In some embodiments, a user device may be in a specific location and may have access to decryption data once within the specific location, which may be communicated to a smart lock from the user device. In some embodiments, encryption of face print 140 may be based on a source camera, such as a camera of a smart lock or image recording device 104. For instance, a serial number or other form of identification of a camera of a smart lock may be used by the smart lock as decryption data. In some embodiments, one or more face prints 140 may be stored on a blockchain. A “blockchain” as used in this disclosure refers to an immutable sequential listing. Blockchain may be a decentralized digital ledger that may securely store records across a network of computers in an immutable way. For instance, a new block in a blockchain may incorporate all previous blocks within the blockchain upon formation, which may aid in resisting tampering of historical data.

A smart lock may be configured to interpret movement of an individual's lips to lip read the individual through a camera through a lip reading analysis. For instance, a smart lock may lip read an individual through obtaining image data of the individual via a camera and may decern that the individual recited a keyword and/or key phrase. In some embodiments, a smart lock may incorporate a microphone or other audio sensing element. A smart lock may utilize a speech recognition process to identify one or more words and/or phrases. A smart lock may obtain audio data of an individual and may process the audio data to identify one or more words and/or phrases spoken by an individual. A smart lock may decern one or more key words and/or phrases spoken by an individual. Upon discernment of one or more key words and/or phrases via lip reading, speech recognition, or other forms of data interpretation, a smart lock may compare the one or more key words and/or phrases with a list of one or more accepted key words and/or phrases. If a match is found between decerned key words and/or phrases and a list of accepted key words and/or phrases, a smart lock may actuate a locking mechanism which may unlock a door smart lock may be incorporated into. In some embodiments, one or more facial features of an individual may be used as decryption data. For instance, one or more facial features of an individual may be combined with a key associated with a smart lock.

In some embodiments, a locking mechanism may be digital. For instance, digital locking mechanisms may be software executable by one or more processors operable to provide or deny access to a device they run on. A digital locking mechanism may be part of a digital system. A “digital system” as used in this disclosure is any object or combination of objects capable of running a software. Digital systems may include, but are not limited to, smart locks, smart sliding doors, smart swing doors, vehicles, electronic game machines, payment terminals, or any other object or combination of objects capable of running a software. A digital system may run on processors of, but are not limited to, smartphones, tablets, laptops, smart locks, cameras, vehicles, electronic game machines, smart sliding doors, smart swing doors, or other devices. A digital system may be configured to receive an encrypted face print 140 and/or encrypted data 108 and decrypt the encrypted face print 140 and/or encrypted data 108. A digital system may utilize any decryption methods described herein. In some embodiments, a digital system may include an image recording device, such as but not limited to a camera. A digital system may obtain image data through an image recording device. In some embodiments, a digital system may be configured to execute one or more facial feature detection algorithms, such as any facial feature running algorithm described herein. Through a facial feature detection algorithm, a digital system may obtain one or more facial features of an individual. A digital system may compare one or more facial features of an individual to a decrypted face print 140, and may operate a locking mechanism based on the comparison. For instance, a digital system may grant a user access to itself or deny a user access to itself based on a comparison of one or more facial features to a decrypted face print 140. In some embodiments, a digital system may grant access or deny access to a user account. A “user account” as used in this disclosure refers to a digital identity associated with a user in a digital system. A user account may include one or more registered face prints 140, one or more registered devices, user settings, or other information. A digital system may unlock one or more system components based on entitlements based on a comparison of facial features with face print 140., For instance a digital system may entitle specific individuals to access account privileges of a user account. A user account may be logged into by a user through a laptop, smartphone, desktop, provision of a face print 140, or other methods. A user account may store user information such as, but not limited to, user credentials, identities, IP addresses, MAC addresses, registered devices, financial information, or other data.

In some embodiments, recordings of video may be associated with a user account. For instance, a user may be identified in image data of an image recording device. Upon identification of an individual in image data of an image recording device, a digital system may store the image data in a user account matching a determined identity of the individual. A plurality of digital systems may record image data specific to individuals at their corresponding user accounts. In some embodiments, a single digital system may be operable to execute two or more user accounts. For instance, a single digital system may grant or deny access to one or more user accounts. A single digital system may store different image data associated with different individual identities under corresponding user accounts.

A digital system may include a payment terminal. A “payment terminal” as used in this disclosure refers to a device in which transaction of currency may occur. For instance, payment terminals may include, but are not limited to, automatic transaction machines (ATMs), point of sale (Pos) systems, or other devices. A digital system may include one or more electronic game machines. An “electronic game machine” as used in this disclosure refers to any device capable of running a video game. Video games may include, but are not limited to, arcade games, casino games, console games, personal computer (PC) games, or other games. For instance, a digital system may include electronic game machines, such as, but not limited to, arcade games, video game consoles, casino games, or other forms of game machines. In some embodiments, digital locking mechanisms may run on a slot machine. In some embodiments, a digital system may allow a user to activate a payment terminal upon authorization to access a user account, which may be associated with the payment terminal. For instance, a user may be authorized to access a user account that may be digitally funded, and may transfer funds to one or more entities form the user account via a payment terminal upon authorization to access the user account.

In some embodiments, a digital system may be configured to operate in two or more modes. For instance, a digital system may be configured to operate in a single activation mode. A “single activation mode” as used in this disclosure refers to the locking or unlocking of an object and/or system based on user authentication/authorization. For instance, a digital system may be configured to operate a locking mechanism, digital or physical, upon authorizing a user, such as through user authentication. For instance, any physical or digital locking mechanism described herein may be unlocked or locked upon successful authentication of a user. In a single activation mode, a digital system may leave a locking mechanism in an unlocked or locked state indefinitely or until some criteria occurs, such as rebooting of a digital system, receipt of subsequent user authentications, or other criteria.

A digital system may be configured to operate in a continuous activation mode. A “continuous activation mode” as used in this disclosure refers to an ongoing authentication of a user to keep a locking mechanism unlocked or locked. A continuous activation mode may run for a period of time, such as, but not limited to, seconds, minutes, hours, or indefinitely. In a continuous activation mode, a digital system may persistently authenticate a user based on image data and/or user authentication to keep a device and/or system unlocked or locked through operation of a physical or digital locking mechanism. For instance, operation of a locking mechanism may be based on a presence of an authenticated user. A presence of an authenticated user may include image data representative of an authenticated user being continually received, for instance and without limitation while an authenticated user is within a field of view of an image recording device of a digital system. In a continuous activation mode, while a presence of an authenticated user is determined by a digital system, the digital system may continually perform one or more actions. For instance, while a presence of an authenticated user is determined, a digital system may perform one or more operations related to a physical or digital locking mechanism. a digital system may be in electromechanical communication with a door handle, and may keep the door handle unlocked through an unlocking of a locking mechanism while a presence of an authenticated user is detected. a digital system may be in electromechanical communication with one or more sliding doors, and may actuate the sliding doors to stay in an open position while a presence of an authenticated user is detected. In embodiments where a digital system is in communication with door handles and/or doors, the digital system may close one or more doors and/or lock one or more locking mechanisms once a presence of an authenticated user is no longer detected.

A digital system may be part of or in communication with a payment terminal. While a presence of an authenticated user is detected, a digital system may allow the authenticated user to interact with a payment terminal, such as but not limited to an ATM or PoS machine. Once a presence of an authenticated user is no longer detected, a digital system may prevent access to a payment machine. Preventing access of a payment machine may include digitally locking the payment machine through a digital locking mechanism. For instance, a graphical user interface (GUI) of a payment terminal may be locked and/or display a message that the payment terminal is locked. In some embodiments the locking mechanism may include restricting or allowing access to an individuals payment accounts or account history.

A digital system may be part of or in communication with an electronic game machine. While a presence of an authenticated user is detected by a digital system, the digital system may allow the authenticated user access to an electronic game machine, such as by digitally unlocking the electronic game machine. In some embodiments, an electronic game machine may be operable to store one or more user accounts. A user may be able to unlock a user account at an electronic game machine through provision of face print 140 or other methods described herein. A user account of an electronic game machine may store information such as, but not limited to, dates and times a user accessed their account at a specific electronic game machine, duration of engagement with the specific electronic game machine, frequency of visits to the specific electronic game machine, or other information. In some embodiments, a user account of an electronic game machine may track a transfer of digital currency, such as loyalty points, digital rewards, credit/debit card transactions, or other information. A user may be able to log into their user account at two or more different electronic game machines. For instance, a user account may be transferable among different electronic game machines. In some embodiments, a user account is transferable among different electronic game machines of a same type. In other embodiments, a user account is transferable among different electronic game machines of a differing type. Two or more electronic game machines may be in communication with a server or other remote computing device. A server or other remote computing device may be configured to record, store, and/or update information of one or more user accounts. An electronic game machine may communicate with a server or other remote computing device to provide a user account to a user that may not have previously accessed the electronic game machine. A server in communication with one or more electronic game machines may track a user's activity across one or more electronic game machines, inclusive of transferring of digital currency, loyalty points, digital redeemable rewards, or other data.

Digitally unlocking the electronic game machine may include rendering one or more user interface elements operable from a previously inoperable or inactive state. In some embodiments the locking mechanism may include restricting or allowing access to an individual's account credits or account history. In some embodiments, digitally unlocking the electronic game machine may include activating a slot handle of an electronic game machine. For instance, a digital system may digitally unlock a slot handle or other user input element of a game machine. In some embodiments digitally activating an electronic game machine may include unlocking a smart lock of a slot handle to allow the slot handle to move. A digital system may record and/or store image data 108 representative of an authenticated user accessing an electronic game machine for a duration or portion thereof that the authenticated user is accessing the electronic game machine. For instance, an authenticated user may access a slot machine in communication with a digital system and may be granted access to the slot machine until the authenticated user leaves a field of view of an image recording device of a digital system or one or more unauthenticated users enter a field of view of the image recording device of a digital system.

In some embodiments, a digital system may be in communication with or part of a vehicle. While a presence of an authenticated user is detected by a digital system, the digital system may allow operation of a vehicle by the authenticated user, such as, but not limited to, starting an engine, unlocking one or more doors, or other operations of the vehicle. For instance an authenticated user may walk up to a car equipped with a digital system. A digital system may detect a presence of an authenticated user as the authenticated user walks towards the car and may unlock one or more doors of the car, start an engine of the car, or perform other operations. A digital system may prevent operation of a vehicle once a presence of an authenticated user is no longer detected by the digital system. Prevention of operation of a vehicle may include, but is not limited to, disabling an engine, locking one or more doors, or other operations.

A digital system may be configured to operate a physical or digital locking mechanism to lock a physical or digital system while a presence of an authenticated user is not detected by the digital system. For instance, an authenticated user may leave a field of view of an image recording device of a digital system, an unauthenticated user may appear in a field of view of the image recording device, or other criteria may occur. As a non-limiting example, a presence of an authenticated user may be created based on user authentication and image data received from an image recording device of a digital system. While the presence of the authenticated user is detected, a digital system may operate locking mechanisms to keep an object or system unlocked. Continuing this non-limiting example, the authenticated user may pass through a pair of sliding doors electromechanically connected to a digital system. A digital system may keep the pair of sliding doors open until the presence of the authenticated user is no longer detected, such as if the user passes through the pair of sliding doors or leaves a field of view of an image recording device a digital system. As another non-limiting example, a presence of an authenticated user may be created at an electronic game machine in communication with a digital system. While the presence of the authenticated user is detected, a digital system may allow the authenticated user to operate the electronic game machine.

In some embodiments, a digital system may be configured to record image data representative of an authenticated user while a presence of a user is detected by the digital system. For instance, a presence of an authenticated user may be detected by a digital system which may trigger the digital system to store recorded image data representative of the authenticated user. Recording of image data representative of an authenticated user may occur in any environment described herein. For instance, recording of image data may occur in digital systems include but is not limited to, electronic game machines, casino games, payment terminals, vehicles, doors equipped with smart locks, or other environments. Data recorded by a digital system representative of an authenticated user may be communicated by the digital system to one or more external computing devices, such as through a wired or wireless connection. Recorded image data representative of an authenticated user may be time stamped, such as the instant a presence of an authenticated user is detected by a digital system to the instant the presence is no longer detected by the digital system. In some embodiments, a digital system may record image data representative of an unauthenticated user. For instance, an unauthenticated user may attempt to access a digital system such as, but not limited to, electronic game machines, payment terminals, vehicles, doors, or other systems/objects described herein, to which the digital system may initiate recording of image data. Recording of image data of an unauthenticated user may be time stamped. For instance, recording of an unauthenticated user may be triggered once the unauthenticated user attempts to access one or more systems described herein and may cease once the unauthenticated user leaves a filed of view of an image recording device of a digital system. Recorded image data of an unauthenticated user may be communicated to one or more external computing devices through a wired or wireless connection. A digital system may communicate one or more alerts to one or more external computing devices based on a detection of an authenticated user attempting to access one or more systems described herein.

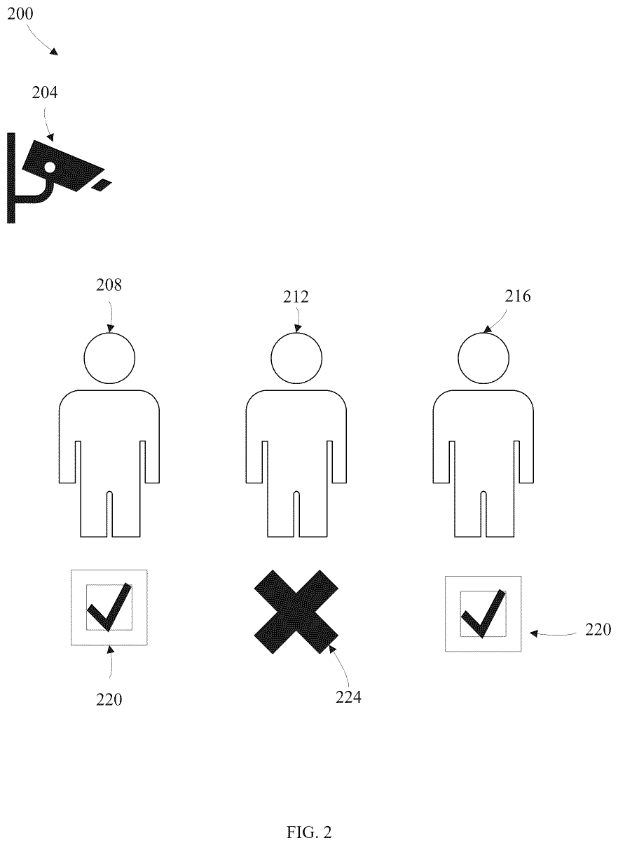

Referring now to FIG. 2, an exemplary embodiment of a system 200 for image privacy is presented. System 200 may include image recording device 204. Image recording device 204 may include image recording device 104 as described above with reference to FIG. 1, without limitation. In some embodiments, system 200 may include a plurality of image recording devices 204. Image recording device 204 may include, without limitation, security cameras, smartphones, tablets, surveillance cameras, and the like. Image recording device 204 may be positioned near and/or in one or more doors, walls, parking lots, residential complexes, and the like. Image recording device 204 may include an on-board computing device, such as, without limitation, computing device 112 as described above with reference to FIG. 1. Image recording device 204 may be configured to detect and/or identify first user 208, second user 212, and/or third user 216. In some embodiments, first user 208, second user 212, and/or third user 216 may be positioned in a same area in front of image recording device 204. In other embodiments, first user 208, second user 212, and/or third user 216 may be presented to image recording device 204 individually, in pairs, and/or any combination thereof. Image recording device 204 may generate a two dimensional face scan of each user. In some embodiments, image recording device 204 may generate a three dimensional face scan of each user, such as through a depth sensor. Image recording device 204 may be configured to register each face of users 208, 212, and/or 216 a face print, such as face print 140 as described above with reference to FIG. 1, without limitation. Image recording device 204 may annotate an image of users 208, 212, and/or 216. Annotation may include highlighting a face of each user and/or obscuring a face of each user of users 208, 212, and/or 216. Image recording device 204 may communicate one or more images to an external computing device, such as, but not limited to, a cloud-computing network. In some embodiments, image recording device 204 may determine positive consent 220 of one or more users. Positive consent 220 may include a registration of a user's face with an identity of a user, which may be provided by the user. Image recording device 204 may be configured to determine negative consent 224. Negative consent 224 may include an unregistered user, revoked identification privileges of a user, and the like. Image recording device 204 may be configured to identity and/or determine positive consent 220 and/or negative consent 224 of a plurality of users that may be in sight of image recording device 204, such as users 208, 212, and/or 216. For example, and without limitation, image recording device 204 may determine user 208 and user 216 have positive consent 220 and user 212 has negative consent 224. Image recording device 204 may generate an alert that user 212 is unidentified and/or a “stranger”. A user, such as user 208, may revoke positive consent 220, to which image recording device 204 may generate negative consent 224 for user 208.

Still referring to FIG. 2, positive consent 220 and/or negative consent 224 may be specific to image recording device 204. For instance, and without limitation, a second image recording device may determine negative consent 224 for users 208 and 216 and positive consent 220 for user 212. One or more users may provide device specific consent, data process specific consent, and the like. Continuing the above example, a second image recording device may determine positive consent 220 for sharing a face print of user 212 and a negative consent 224 for sharing a face print of users 208 and/or 216 while image recording device 204 may determine positive consent 220 for users 208 and 216 for using a face print for door security login credentials, such as a smart door.

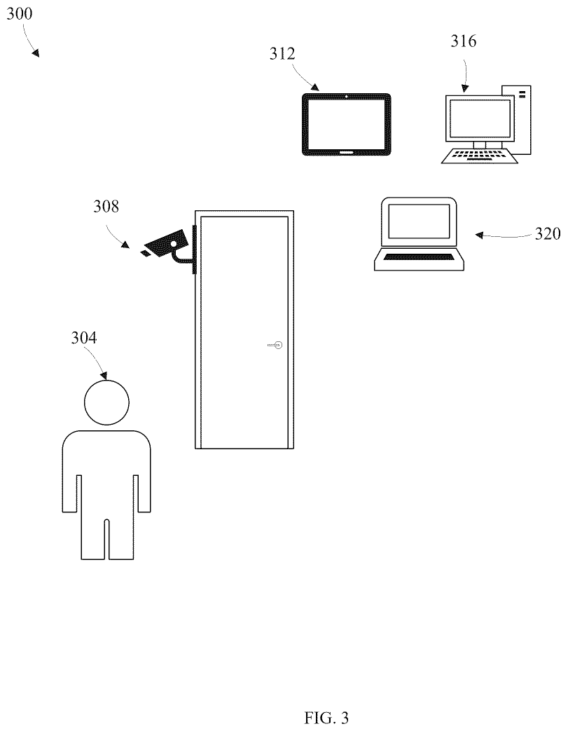

Referring now to FIG. 3, an exemplary embodiment of a system 300 for a user presence is presented. System 300 may include image recording device 308. Image recording device 308 may include, without limitation, image recording device 104 as described above with reference to FIG. 1. Image recording device 308 may be configured to detect and/or generate image data of user 304. Image recording device 308 may include an on-board computing device, such as computing device 112 as described above with reference to FIG. 1, without limitation. In some embodiments, image recording device 308 may communicate with an external computing device, such as, but not limited to, a laptop, desktop, tablet, server, cloud-computing network, and the like. Image recording device 308 may perform one or more processes on-board and/or communicate one or more processes with an external computing device, “offloading” one or more computing tasks to the external computing device.

Still referring to FIG. 3, image recording device 308 may compare image data of user 304 with one or more face prints of a facial database. In other embodiments, image recording device 308 may generate a face print of user 304 in real-time. User 304 may provide a user authorization prior to, during, and/or after an interaction with image recording device 308. For instance, and without limitation, image recording device 308 may recognize and/or otherwise identify user 304 during an initial presentation of user 304 to image recording device 308. In some embodiments, image recording device 308 and/or a computing device in communication with image recording device 308 may communicate with a user device user 304 may be in possession of. A user device may include, without limitation, a smartphone, tablet, laptop, VR headset, and the like. Image recording device 308 and/or a computing device in communication with image recording device 308 may prompt user 304 through a user device to provide a user authorization, such as user authorization 128 as described above with reference to FIG. 1, without limitation. A user authorization provided by one or more users 304 may include a positive and/or negative consent for one or more data processes. In an embodiment where a positive consent is provided, image recording device 308 may record and/or identify user 304, provide a face print of user 304 with one or more external computing devices, and/or generate a audit record of events where user 304 is identified. In some embodiments, image recording device 308 may communicate with one or more of first computing device 312, second computing device 316, and/or third computing device 320. Computing devices 312, 316, and/or 320 may be in communication with each other through a local area network (LAN), cloud network, and/or other forms of communication such as, without limitation, Wi-Fi, Bluetooth, and the like.

Still referring to FIG. 3, a positive consent of user 304 may allow for a user presence of user 304. A user presence may include image recording device 308 and/or computing device 312, 316, and 320 to detect and/or recognize user 304 through a shared face print, without limitation. For instance, as a non-limiting example, image recording device 308 may compare data of user 304 with a face print of user 304 having a positive consent. A comparison may be local and/or through communications with one or more external computing devices. A positive consent may allow image recording device 308 to communicate an identification of user 304 with computing devices 312, 316, and/or 320. Computing devices 312, 316, and/or 320 may be configured to recognize user 304 based on a shared face print from a facial database and/or image recording device 308. A face print of user 304 may include one or more permissions for image recording device 308 and/or computing devices 312, 316, and 320 to perform one or more data processes. For instance and without limitation, a positive consent of user 304 may allow image recording device 308 to use a face print of user 304 to unlock a security door in communication with image recording device 308. A positive consent may allow computing devices 213 and/or 320 to utilize a face print of user 304 to unlock each of computing device 312 and/or 320, but not computing device 316, without limitation. Any combination of computing devices 312, 316, 320, and/or image recording device 308 may share a positive consent to utilize a face print of user 304, without limitation. User 304 may revoke a positive consent for one or more devices, data processes, and the like, at any time. One or more of computing devices 312, 316, 320, and/or image recording device 308 may not recognize user 304 and/or delete data associated with user 304 based on a revoked positive consent. In some embodiments, a positive consent may be location specific. For instance, user 304 may carry computing device 312 from a first building to a second building. At a first building, computing device 312 may have positive consent from user 304 to identify and/or recognize user 304. At a second building, computing device 312 may have a negative consent to recognize and/or identify user 304, such that user 304 may appear as a “stranger”. Any combination of locations, computing devices, and/or positive or negative consents may be used, without limitation.

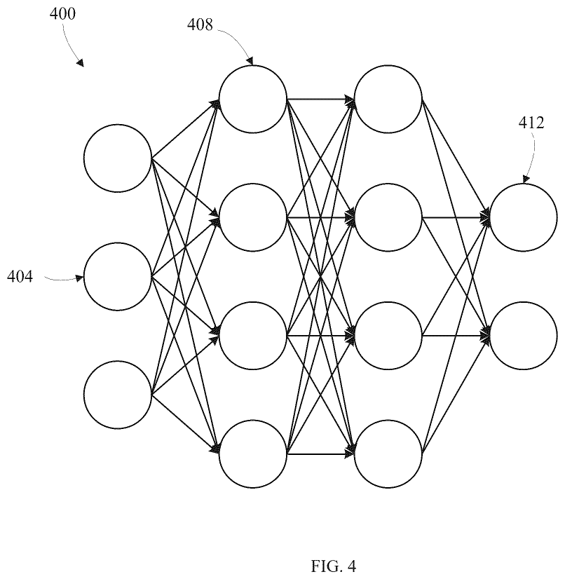

Referring now to FIG. 4, a neural network is presented. A neural network is a data structure that is constructed and trained to recognize underlying relationships in a set of data through a process that mimics the way neurological tissue in nature, such as without limitation the human brain, operates. Neural network 400, includes a network of “nodes,” or data structures having one or more inputs, one or more outputs, and functions determining outputs based on inputs. Such nodes may be organized in a network, such as without limitation a convolutional neural network (CNN). A network of nodes may include an input layer of nodes 404, one or more intermediate layers 408, and an output layer of nodes 412. Intermediate layers 408 may also be referred to as “hidden layers”. Connections between nodes may be created via the process of “training” neural network 400, in which elements from a training dataset are applied to the input nodes. A suitable training algorithm, such as without limitation Levenberg-Marquardt, conjugate gradient, simulated annealing, and/or other algorithms may be used to adjust one or more connections and weights between nodes in adjacent layers, such as intermediate layers 408 of neural network 400, to produce desired values at output nodes 412. This process is sometimes referred to as deep learning.

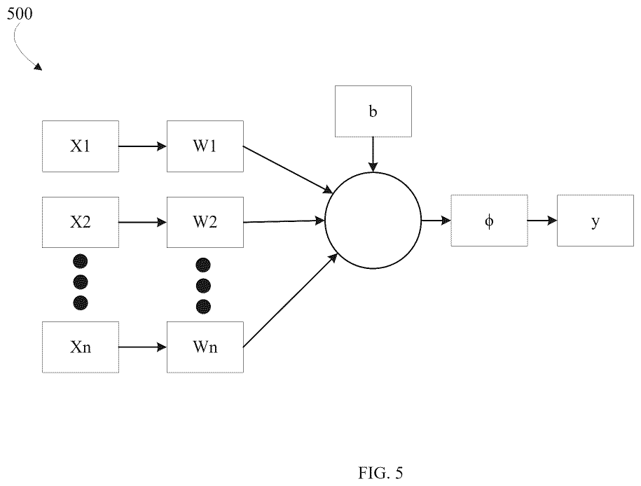

Referring now to FIG. 5, an exemplary neural network is shown where nodes may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

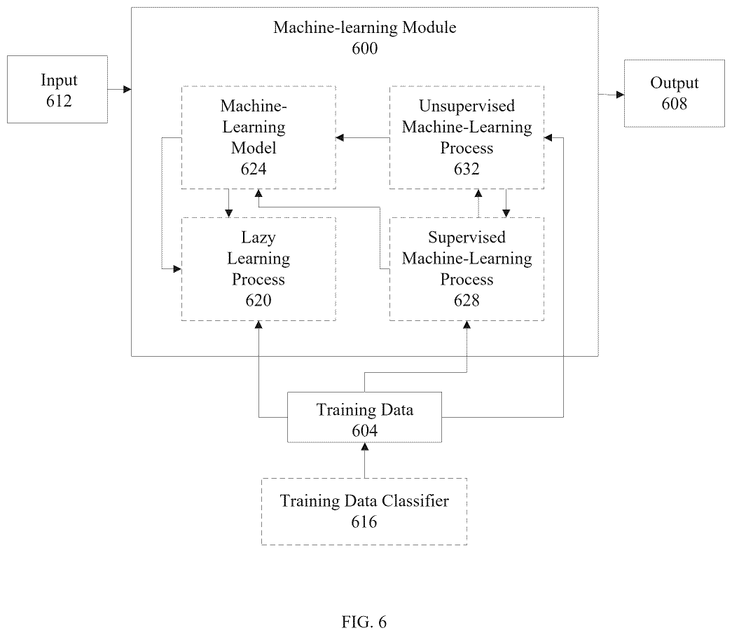

Referring to FIG. 6, an exemplary machine-learning module 600 may perform machine-learning process(es) and may be configured to perform various determinations, calculations, processes and the like as described in this disclosure using a machine-learning process.

Still referring to FIG. 6, machine learning module 600 may utilize training data 604. For instance, and without limitation, training data 604 may include a plurality of data entries, each entry representing a set of data elements that were recorded, received, and/or generated together. Training data 604 may include data elements that may be correlated by shared existence in a given data entry, by proximity in a given data entry, or the like. Multiple data entries in training data 604 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations. Correlations may indicate causative and/or predictive links between categories of data elements, which may be modeled as relationships such as mathematical relationships by machine-learning processes as described in further detail below. Training data 604 may be formatted and/or organized by categories of data elements. Training data 604 may, for instance, be organized by associating data elements with one or more descriptors corresponding to categories of data elements. As a non-limiting example, training data 604 may include data entered in standardized forms by one or more individuals, such that entry of a given data element in a given field in a form may be mapped to one or more descriptors of categories. Elements in training data 604 may be linked to descriptors of categories by tags, tokens, or other data elements. Training data 604 may be provided in fixed-length formats, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 6, training data 604 may include one or more elements that are not categorized. Uncategorized data of training data 604 may include data that may not be formatted or containing descriptors for some elements of data. In some embodiments, machine-learning algorithms and/or other processes may sort training data 604 according to one or more categorizations. Machine-learning algorithms may sort training data 604 using, for instance, natural language processing algorithms, tokenization, detection of correlated values in raw data and the like. In some embodiments, categories of training data 604 may be generated using correlation and/or other processing algorithms. As a non-limiting example, in a body of text, phrases making up a number “n” of compound words, such as nouns modified by other nouns, may be identified according to a statistically significant prevalence of n-grams containing such words in a particular order. For instance, an n-gram may be categorized as an element of language such as a “word” to be tracked similarly to single words, which may generate a new category as a result of statistical analysis. In a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure, without limitation.

Further referring to FIG. 6, training data 604 may be filtered, sorted, and/or selected using one or more supervised and/or unsupervised machine-learning processes and/or models as described in further detail below. In some embodiments, training data 604 may be classified using training data classifier 616. Training data classifier 616 may include a classifier. A “classifier” as used in this disclosure is a machine-learning model that sorts inputs into one or more categories. Training data classifier 616 may utilize a mathematical model, neural net, or program generated by a machine learning algorithm. A machine learning algorithm of training data classifier 616 may include a classification algorithm. A “classification algorithm” as used in this disclosure is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine-learning module 600 may generate a classifier, such as training data classifier 616 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to one or more faces.

Still referring to FIG. 6, machine-learning module 600 may be configured to perform a lazy-learning process 620 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Still referring to FIG. 6, machine-learning processes as described in this disclosure may be used to generate machine-learning models 624. A “machine-learning model” as used in this disclosure is a mathematical and/or algorithmic representation of a relationship between inputs and outputs, as generated using any machine-learning process including without limitation any process as described above, and stored in memory. For instance, an input may be sent to machine-learning model 624, which once created, may generate an output as a function of a relationship that was derived. For instance, and without limitation, a linear regression model, generated using a linear regression algorithm, may compute a linear combination of input data using coefficients derived during machine-learning processes to calculate an output. As a further non-limiting example, machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include supervised machine-learning process 628. A “supervised machine learning process” as used in this disclosure is one or more algorithms that receive labelled input data and generate outputs according to the labelled input data. For instance, supervised machine learning process 628 may include images as described above as inputs, cropped faces of images as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

Further referring to FIG. 6, machine learning processes may include unsupervised machine-learning processes 632. An “unsupervised machine-learning process” as used in this disclosure is a process that calculates relationships in one or more datasets without labelled training data. Unsupervised machine-learning process 632 may be free to discover any structure, relationship, and/or correlation provided in training data 604. Unsupervised machine-learning process 632 may not require a response variable. Unsupervised machine-learning process 632 may calculate patterns, inferences, correlations, and the like between two or more variables of training data 604. In some embodiments, unsupervised machine-learning process 632 may determine a degree of correlation between two or more elements of training data 604.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array), an ASIC (application specific integrated circuit), non von neumann architectures, neuromorphic chips, and deep learning chips.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including, by way of example, semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A smart lock system, comprising:
a computing device in communication with an image recording device and a digital system, the computing device configured to:
detect a human face within image data obtained from the image recording device using a facial recognition process;
generate a face print of the human face;
encrypt the face print; and
communicate the encrypted face print to the digital system, wherein the digital system is configured to:
decrypt the encrypted face print;
obtain image data through a separate image recording device;
extract one or more facial features through a facial recognition process;
compare the one or more facial features from the image data to the decrypted face print; and
operate a locking mechanism based on the comparison to grant the user access to the digital system.

2. The system of claim 1, wherein the digital system is a smart lock, payment terminal, vehicle, or electronic game machine.

3. The system of claim 1, wherein the digital system is further configured to operate in a single activation mode.

4. The system of claim 1, wherein the digital system is further configured to operate in a continuous activation mode.

5. The system of claim 4, wherein the digital system is further configured to exit the continuous activation mode once a presence of an authenticated user is no longer detected.

6. The system of claim 1, wherein the digital system is further configured to operate the locking mechanism to prevent access to the digital system to a user based on the authentication.

7. The system of claim 6, wherein the digital system is further configured to record image data representative of an authenticated user attempting to access the digital system.

8. The system of claim 1, wherein the digital system is further configured to record image data representative of the user while the user is within a field of view of the image recording device.

9. The system of claim 1, wherein the locking system is a digital locking system.

10. The system of claim 1, wherein the digital system is further configured to unlock a user account based on the face print.

11. A method of operating a locking mechanism of a digital system, comprising:
receiving an encrypted face print from a computing device;
decrypting the face print;
obtaining image data an individual through an image recording device;
extracting one or more facial features of the individual through a facial recognition process;
comparing the one or more facial features to the face print; and
operating a locking mechanism based on the comparison.

12. The method of claim 11, wherein the digital system is a smart lock, payment terminal, vehicle, or electronic game machine.

13. The method of claim 11, further comprising operating the locking mechanism in in a single activation mode of the digital system.

14. The method of claim 11, further comprising operating the locking mechanism in a continuous activation mode of the digital system.

15. The method of claim 14, further comprising ceasing the continuous activation mode once a presence of an authenticated user is no longer detected.

16. The method of claim 11, further comprising operating the locking mechanism to prevent access to the digital system to a user based on the comparison.

17. The method of claim 16, further comprising recording image data representative of an authenticated user attempting to access the digital system.

18. The method of claim 11, further comprising recording image data representative of the user while the user is within a field of view of the image recording device.

19. The method of claim 11, wherein the locking system is a digital locking system.

20. The method of claim 11. further comprising generating an alert of a detection of an unauthenticated user by the digital system.
